(19) United States
(12) Patent Application Publication
(10) Pub. No.: US 2008/0148231 A1
(43) Pub. Date: Jun. 19, 2008

(54) Computer-implemented system for analysis, administration, control, management and monitoring of a complex hardware/software architecture

(76) Inventor: Thomas Weber, St. Gallen (CH)

Correspondence Address: PAUL, HASTINGS, JANOFSKY & WALKER LLP, 875 15th Street, NW, Washington, DC, 20005, US

(21) Appl. No.: 11/727,265

(22) Filed: Mar. 26, 2007

(30) Foreign Application Priority Data
Dec. 15, 2006 (EP) 06 026 089.0

(51) Int. Cl. G06F 9/44

(52) U.S. Cl. 717/120

(57) ABSTRACT

A method for execution in a computer network of several node computers and a plurality of program components, which are distributed instanced on one of the node computers and with predetermined input parameters for addressing a functionality of this program component and with predetermined output parameters after its execution, in which by communication with these program components state information (e.g., about the architecture of the computer network, the configuration status of the hardware resources of the computer network, event and error messages of the hardware resources of the computer network, the development status or the version of the software program components, the runtime behavior of the software program components, and events and errors of the software program components) is recorded with time, space, functional and/or structural descriptors, stored in a database, and, dependent on queries, output in one or more standardized output formats.

This application claims the benefit of European Patent Application No. 06026089.0, filed Dec. 15, 2006, which is herein incorporated by reference in its entirety.

### BACKGROUND

1. Field of the Invention

The present invention relates generally to complex information technology (IT) environments in which application programs are stored on and accessed over a network of computers and, more particularly, to methods and systems for monitoring and managing such complex IT environments.

2. Background of the Invention

Many organizations base their business on networked computers, in which many application programs, which are called by users, access the resources (hardware or software or infrastructure) of a network of computers via middleware, operating systems, and other computer program components. But, IP-based (IP=Internet Protocol) access to resources in the computer network is also becoming increasingly widespread for implementing and executing business processes in an information technology (IT) environment.

This situation also results from that fact, for a specific application, computer programs containing the complete required functionality have hitherto usually been used. Thus, it is possible that another application needs a similar or identical functionality. In this case, this functionality was implemented in parallel or redundantly. The great advantage of this solution is the independence. Each application program for implementing a process can be enhanced and operated individually.

In contrast, work is increasingly done today according to the concept of redundancy-free applications, in which a software system is split up into reusable components. In addition, interfaces that are offered by these components make them more suitable for reuse and multiple use. The consequence and the aim here are redundancy-free and highly reusable systems, with complex dependencies of the reusable components. In other words, the required functionalities are implemented in autonomous components, which can be called and used from a different side. As well as the lower maintenance costs, it is thereby advantageously ensured that only one version of a functionality exists. This means that two application program components ‘A’ and ‘B’ obtain the identical result, which is supplied by only one autonomous component ‘C.’ In addition to the advantages of this approach, an obvious result is especially the diverse dependencies caused by increased complexity. The following questions are among those arising: What happens with ‘A’ and ‘B’ if the autonomously developed component ‘E’ is modified? Which application program components are affected by a change? What happens if the autonomous component ‘C’ contains an error?

### TECHNICAL PROBLEMS UNDERLYING THE INVENTION

Especially with larger and also geographically widely distributed components of the computer network, individual resources are multiply provided even with the concept of the redundancy-free application software system, not least on grounds of performance and of minimizing outage of the computer network. It is essential here that the multiply provided resources actually are identical to one another. Otherwise, the result would be faults in operation that were difficult to trace: Imagine a computer program for a complicated computation process that is only supposedly identically present on two servers in the computer network. An application program whose request for a computation is directed (routed) by the network protocol at one time to a first instance of the computer program, and at a different time to a second instance of the computer program, will return differing results, dependent on random factors that are practically untraceable. The situation is comparable with hardware components that are only apparently identical (processors, network channels, etc.). The access of a first computer program over a heavily used network channel to a server with a second computer program for executing a computation or a database query can lead to a time-out for the requesting computer program, while the access of the first computer program over a less heavily used network channel to another server with a different instance of the second computer program returns the computation or the database query to the requesting computer program without problems (since it occurs within the expected timeframe).

Furthermore, it becomes increasingly difficult, as the dependencies of the hardware and software systems and their interdependencies become ever more complex, to recognize effects of a (hardware or software) change on other software or hardware.

A further problem is the fact that currently, in the planning and implementation of computer programs, these are often equipped with functionalities whose benefit/relevance for the actual use can only be included in the plans with difficulty. Thus, for example, it is difficult to estimate the intervals at which certain functions or autonomous components are called, how long their runtimes are, what other autonomous components they in turn call, what data flows they cause/need, and other similar questions.

It is known for certain factors to be estimated within simulations, and the information from highly specialized software tools to be included in the planning, creation, installation, monitoring, etc. However, these known software tools each return only limited, non-networked aspects.

### BRIEF SUMMARY OF THE INVENTION

To solve these problems, according to an embodiment of the present invention, a computer-implemented system is provided in a network of several node computers and a plurality of program components, which are distributed instanced on one of the node computers and have a predetermined interface in each case, it being specified according to the interface what inputs should be applied to address a functionality of this software program component and what outputs the respective functionality (this software program component) will supply after its execution, the system according to the embodiment of the present invention providing a software program/program component application landscape, which by communication with these software program components records state information from software program resources and/or hardware resources in the computer network, namely about the architecture of the computer network, the configuration status of the hardware resources of the computer network, event and error messages of the hardware resources of the computer network, the development status or the version of the software program components, the runtime behavior of the software program components, events and errors of the software program components, the data flow between individual software program components and/or hardware resources of the computer network, and/or introduction and change requirements and information for the hardware resources of the computer network or the software program components. The system according to an embodiment of the present invention records this state information with time, space, functional and/or structural descriptors, preferably storing it in a database, and, dependent on queries, outputting it in one or more standardized output formats.

Especially in complex IT environments, this computer-implemented system allows a more efficient and safer exposure of errors, along with the analysis/correction of the causes of errors, especially in comparison to previous approaches. In particular, this computer-implemented system according to the invention supports the architecture conception, the development, the integration, and the debugging, the operation, the event and error management, and monitoring of complex IT environments. In other words, the invention supplies a concept, as well as standardizing all necessary/available information about the software, software versions, the hardware, data flows, development information, monitoring information, etc., from the existing tools and from new ones, and, to manage the complexity, represents them graphically with their dependencies within a computer program component application landscape.

A uniform static or dynamic data structure is used here for the entry of the IT assets (e.g., hardware, software, and infrastructure) and their operation (processes, services, resources, etc.). Data streams and requirements for their volume, the properties of their occurrence/appearance (e.g., times, from where to where), and the executions of programs are automatically entered and monitored. Using the data thereby obtained, errors and breakdowns are investigated and minimized, and dependencies between separate program components and/or hardware resources of the computer network are detected. Based on this, change requirements can be determined and changes can be designed. It can be detected, for example, whether a program component or a hardware asset is required from several sides within a certain timeframe, so that wait times ensue for the individual requirements. As a remedy, one or more further instances of the program component can then be made available on different servers, for example, so that the wait times are reduced and the overall capacity of the system increases more than proportionately.

One result that this system can return is that dependencies between individual components or assets can very quickly be detected and analyzed, so that their influences on planned or desired changes are foreseeable. It is furthermore possible, with the analysis of the accumulating statistical data and the accumulating event data, to raise or optimize the efficiency of programs or the usage of hardware assets.

Depending on its complexity, a program component can be a simple function or procedure, a technical component or the like, but also a multilayered and sophisticated business service, which in turn accesses many simpler program components.

According to an embodiment of the present invention, an integral multi-stage approach is selected here:
(i) Even in the outline planning/structuring of a program component and its relationships to other program components, the relevant (static) data is electronically structured and documented.
(ii) This is continued in the programming/coding of a program component, this relevant data being accessed on the one hand, and on the other hand, this data being refined in presentation and supplemented with function calls, parameter transfer, dynamic attributes, etc.
(iii) During the lifetime of the program component, this data is also further supplemented with version information, runtime behavior, etc.
(iv) At the runtime of the program component, this data is drawn upon, in order for the static and dynamic behavior of the program component to be evaluated with its output log file entries by the computer program component application landscape, and verified and output in a suitable manner.

The output occurs in a form that reproduces the relationships to, and/or dependencies on, other resources in the computer network.

There can be a static, dynamic, and/or multilevel output of this state information. The communication between the computer program component application landscape and the program components can take place in batch processing and/or in real time for the state information.

The display of the program component for which an operational error was communicated to the computer program component application landscape, as state information, is preferably together with the computer program components that are dependent on this program component, and/or with its involved hardware resources in the computer network. Computer program components dependent on this computer program component are, for example, those that supply information on request to the computer program component. Involved hardware resources are such as are called upon to execute the computer program component, or for its communication with dependent computer program components.

The display of the program component for which a user error was communicated to the computer program component application landscape, as state information, is preferably together with its dependent computer program components, current data records and/or its involved hardware resources in the computer network.

The display can include a measure of quality of service (QoS) for a program component, and performance statistics including the average response time (target−actual), the minimum response time (target−actual), the maximum response time (target−actual), the time of last access, the number of accesses per time unit, and so on.

One embodiment of the present invention provides a method for execution in a computer network of several node computers and a plurality of program components, which are distributed instanced on one of the node computers and with predetermined input parameters for addressing a functionality of this program component and with predetermined output parameters after its execution, in which by communication with these program components state information from software program resources and/or by communication with hardware resources in the computer network, namely about the architecture of the computer network, the configuration status of the hardware resources of the computer network, event and error messages of the hardware resources of the computer network, the development status or the version of the software program components, the runtime behavior of the software program components, events and errors of the software program components, the data flow between individual software program components and/or hardware resources of the computer network, and/or introduction and change requirements and information for the hardware resources of the computer network or the software program components, is recorded with time, space, functional and/or structural descriptors, stored in a database, and, dependent on queries, output in one or more standardized output formats.

### BRIEF DESCRIPTION OF THE DRAWINGS

FIG. 1 is a schematic diagram of a system comprising software programs, hardware resources, program components, and an application landscape, in accordance with an embodiment of the present invention.

FIG. 2 is a schematic diagram illustrating an output of an object, according to an embodiment of the present invention.

FIG. 3 is a schematic diagram of exemplary user interface showing a detail view of the governance of a front-end component “Card Banking” with its immediate environment, according to an embodiment of the present invention.

FIG. 4 is a schematic diagram of an exemplary user interface showing a hierarchical view of the governance of several components with their immediate environment, according to an embodiment of the present invention.

FIG. 5 is a schematic diagram of an exemplary user interface showing a hierarchical view of the IT service management of several hardware components with their immediate environment, according to an embodiment of the present invention.

FIG. 6 is a schematic diagram of an exemplary user interface showing a hierarchical view of the IT service management of several software components with their immediate environment, according to an embodiment of the present invention.

FIG. 7 is a schematic diagram of an exemplary user interface showing a highest-level component of a program solution, according to an embodiment of the present invention.

FIG. 8 is a schematic diagram of an exemplary user interface illustrating release stages (software release management) of different program components at the business application detail level, according to an embodiment of the present invention.

FIG. 9 is a schematic diagram illustrating an interaction in an exemplary computer-implemented system of an embodiment of the present invention, in which software program components enter state information about the execution in log files (or agents) during their execution.

FIG. 10 is a schematic diagram that illustrates an exemplary event evaluation, according to an embodiment of the present invention.

### DETAILED DESCRIPTION OF THE INVENTION

A computer-implemented system according to an embodiment of the present invention serves in complex IT environments providing a more efficient and safer exposure of errors, along with the analysis/correction of causes of errors, than previous approaches. In particular, the computer-implemented system according to an embodiment of the invention supports the architecture conception, the development, the integration, the debugging, the operation, the event and error management, and the monitoring of complex IT environments. The computer-implemented system records, edits, and prepares events for graphic display, which cover the graphic visualization of a complex IT environment with its hardware, software, and infrastructure components including its state, operational conformity (i.e., governance), IT service management, development, interdependencies of the hardware/software components, software version management, those responsible (owner, service, support) for the individual components, and their relationships to one another.

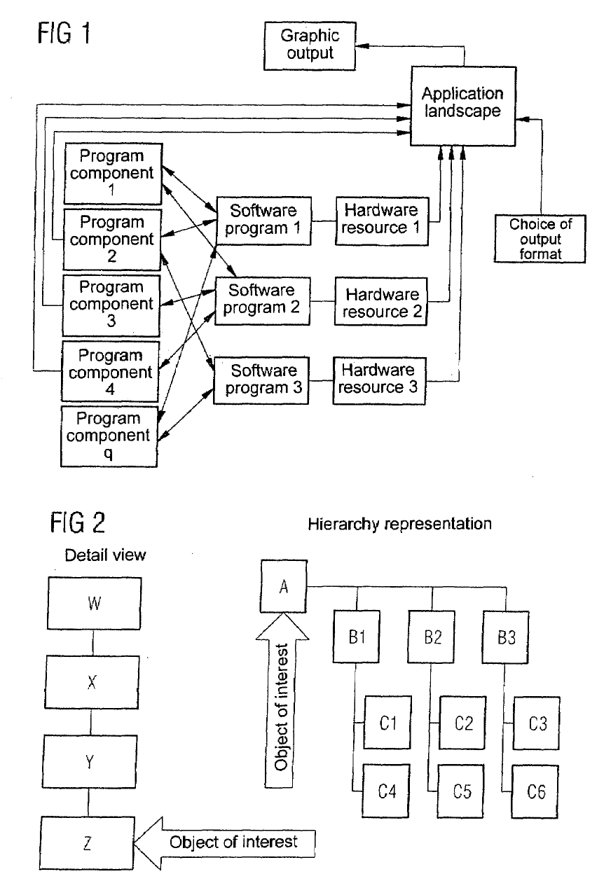

As globally illustrated in FIG. 1, several software programs 1 . . . n are present in an IT environment, and themselves access different hardware resources 1 . . . p, and also each communicate with different program components 1 . . . q, i.e., supply output data and receive input data over specified interfaces. Data can be exchanged directly, i.e., a software program needs a result of a computation and therefore sends the code for the required functionality to a library of functionalities, for example, along with the necessary input data for this functionality. The library selects the corresponding functionality and passes the input data. The input data is processed by the functionality and the output data is returned from the library to the interface of the software program. According to an embodiment of the present invention, both the software program and the program component in which the library is instanced notify the application landscape about this operation. Alternatively, the data exchange can also take place using files, which are stored in databases and accessed alternately for reading/writing. In this case too, both the software program and the program component send a corresponding message to the application landscape about their respective activities.

In the application landscape, these messages are recorded, sorted, stored in a database, evaluated using rules from a rule pool, and sent on request and dependent on the choice of output format, to a graphic output (e.g., screen, printer, and/or plotter).

As illustrated in FIG. 2, the output of an object preferably occurs always in the same view to enable clear and unique classification. An object can be any IT asset, a program, a hardware component, or an infrastructure component, or a property/description of the same. Depending on the desired representation, it is possible to choose between a detail view and a hierarchy representation, in which the object of interest is shown optionally as a subordinate object (e.g., object Z of the detail view of FIG. 2) or as a priority (e.g., object A of the hierarchy representation of FIG. 2). The entry point into the choice of representation is determined in each case by the object of interest.

A further criterion for the choice of output format is the nature of the question concerned. The following questions are possible:

(1) Display of the cause of an error, and its dependencies, in a service interruption:
a. Which component shows faulty behavior, and which services does this component use, and by which services is this component used?
b. Which component shows sub-optimal behavior, and which transactions are affected by this?

(2) Display of the dependencies and networkings (for orientation, training, etc.).

(3) Display of the IT environment for performing analyses of influences:
a. Software
   i. Which components/which services are affected when a component fails?
   ii. Which components/which services are affected when a component's availability is restricted?
   iii. What is the effect on the components/services i, j, k from making the component m multiply available?
   iv. What time does a component need for supplying a service?
b. Hardware/Infrastructure
   i. Which areas are affected if the computer system X fails?
   ii. Which areas are affected if the network Y has only a reduced capacity?
   iii. What is changed if an expanded capacity is provided?

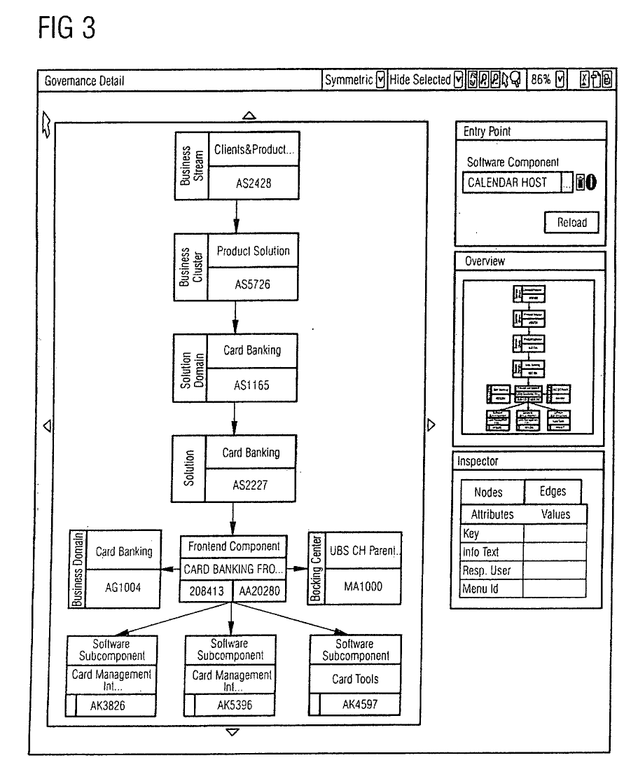

FIGS. 3-8 illustrate various representations (e.g., graphical user interfaces), dependent on the choice of output format, illustrating from an organizational angle the domain of a software program, the program solution, and the program components, and differing in the level of detail and focus of the view. In each case, a large window shows a magnified detail view and a smaller window shows an overview.

FIG. 3 shows, for example, a detail view of the governance of a front-end component “Card Banking” with its immediate environment, i.e., the components that access it and that it accesses.

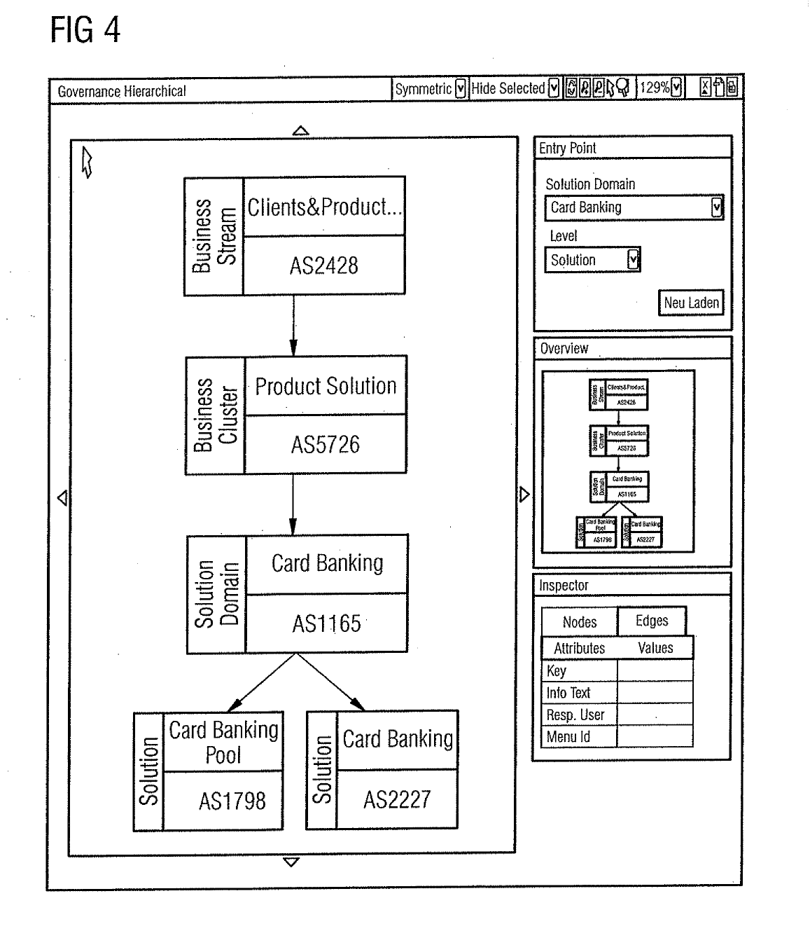

FIG. 4 shows, for example, a hierarchical view of the governance of several components with their immediate environment, i.e., the components that access them and that they access in a wider environment.

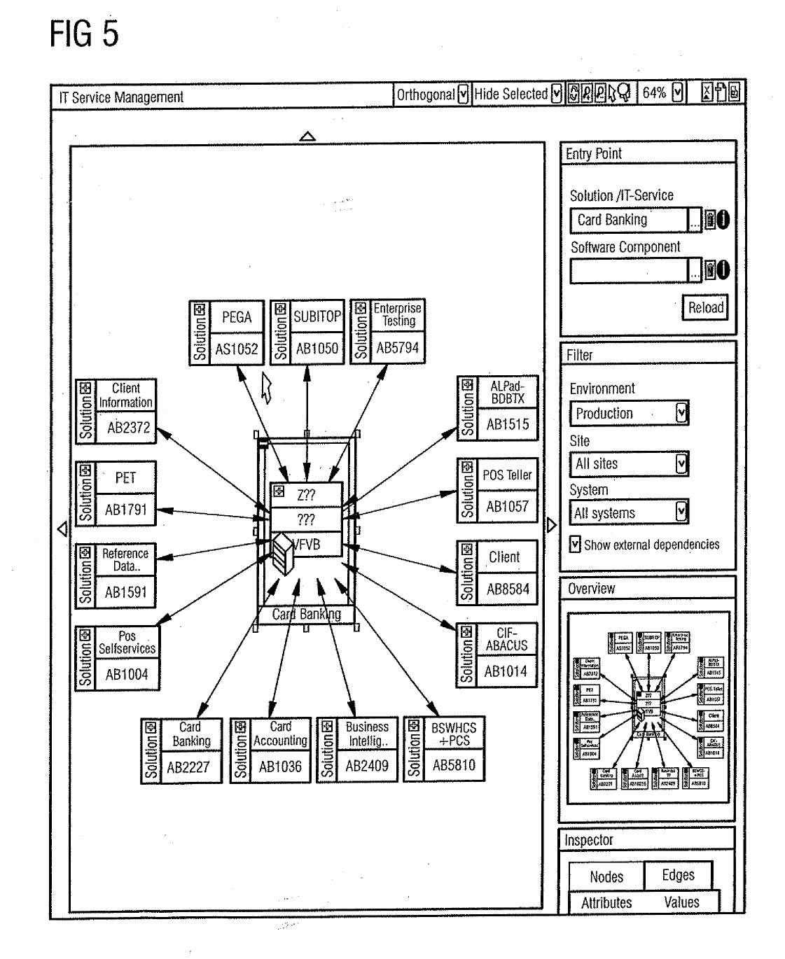

FIG. 5 shows, for example, a hierarchical view of the IT service management of several hardware components with their immediate environment, i.e., the components that access them and that they access.

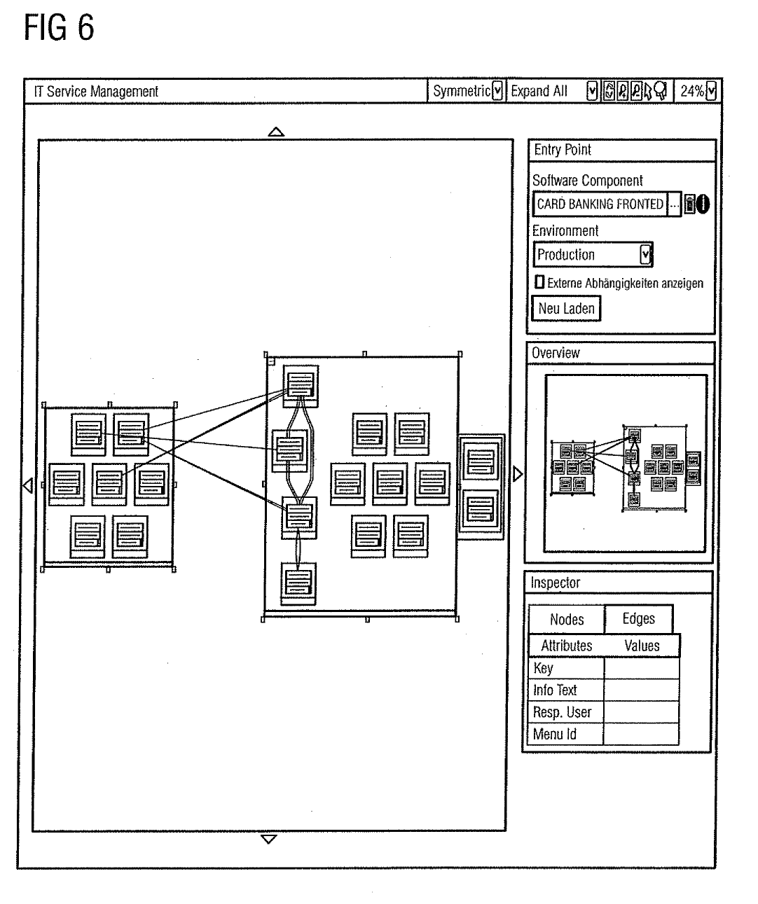

FIG. 6 shows, for example, a hierarchical view of the IT service management of several software components with their immediate environment, i.e., the components that access them and that they access.

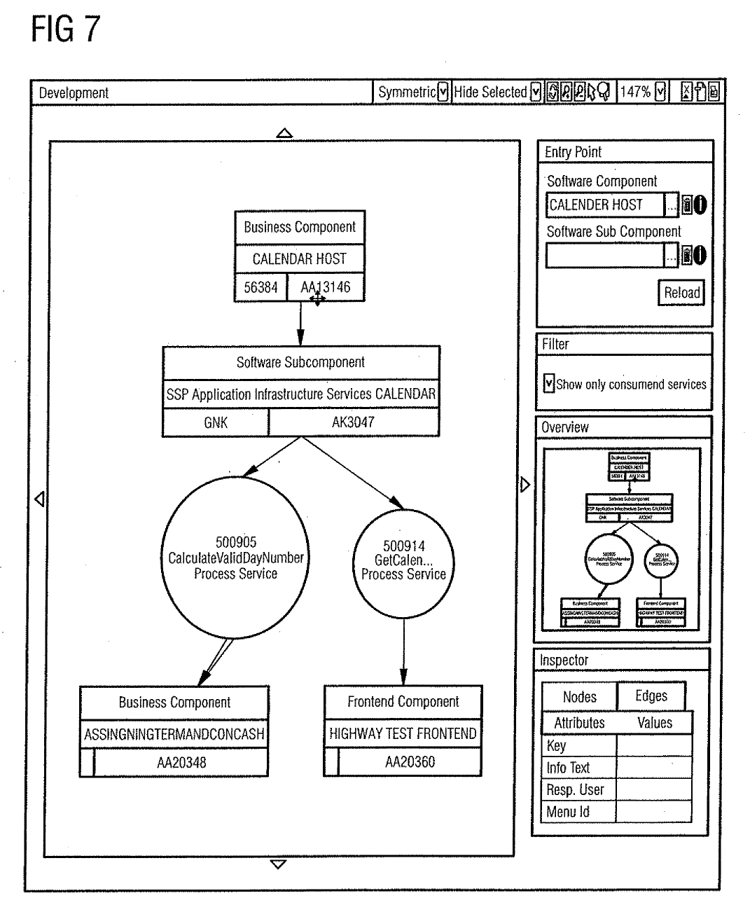

FIG. 7 shows the highest-level component of a program solution, in this case the “Calendar Host,” in the development stage, according to an embodiment of the present invention.

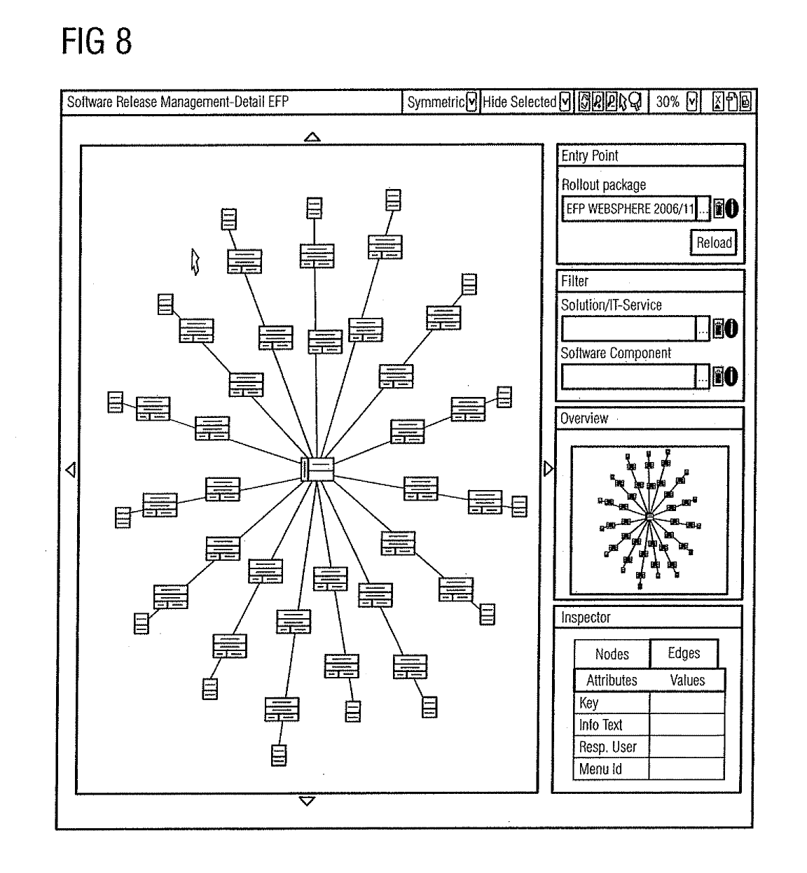

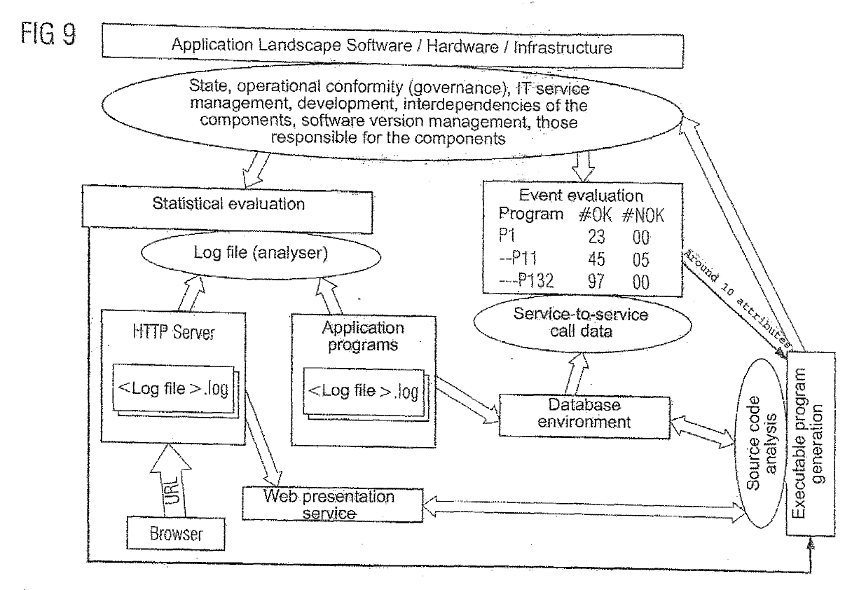

Finally, FIG. 8 illustrates exemplary release stages (software release management) of different program components at the business application detail level, according to an embodiment of the present invention.

The views of FIGS. 3-8 are, of course, only examples and further views can also be implemented within the spirit and scope of the present invention. The different views also can allow individual aspects to be shown or hidden, dependent on the entry point and on context-dependent filter categories (e.g., [solution/IT service], [software component], and [environment]).

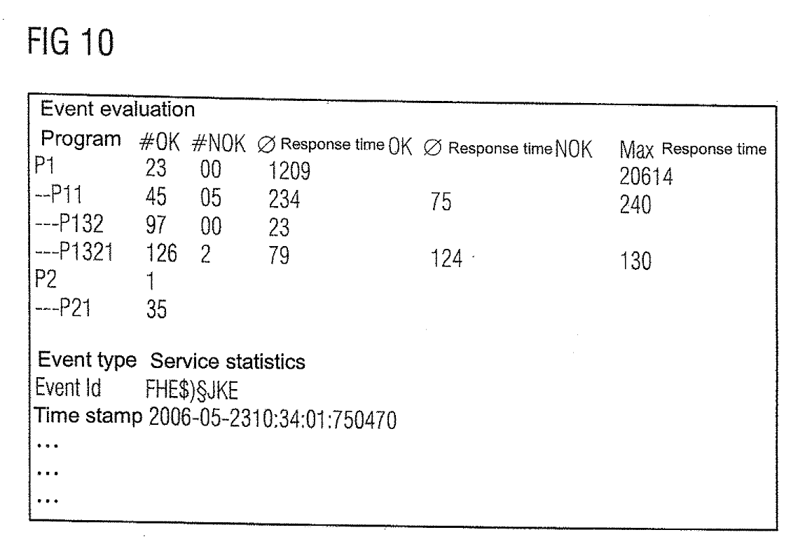

FIG. 9 illustrates an exemplary interaction in a computer-implemented system of the present invention, in which software program components enter state information about the execution in log files (or agents) during their execution. These log files undergo statistical evaluation. In addition, all database accesses and service accesses to a database environment and to the other components are registered and checked in an event evaluation, a log being kept of the individual program components, the number of their calls, and also the program components calling them and the result of the processing (OK/NOK), duration of processing, etc. FIG. 10 illustrates an exemplary event evaluation. The version of the software program components, their runtime behavior, events and/or errors connected with them, the data flow between individual software program components and/or hardware resources of the computer network, etc. are recorded and edited with time, space, functional, and/or structural descriptors. This information from the statistical evaluation and from the event evaluation (for example, in each case up to about 10 attributes for each event/statistical entry) is fed to a source code analysis. The results of the source code analysis are augmented with software development data and forwarded for output through the application landscape. In the application landscape, a save can also take place, so that the results can be output in one or more standardized output formats dependent on queries. The application landscape also contains a rule pool, which it uses to determine what should be rated as a fault, when what data is accepted from the individual data sources or is queried by these, and so on.

Thus, as described herein, the tangible output of the system or method of the present invention includes the creation of graphical user interface displays, such as those shown in FIGS. 3-8, the creation of event evaluation displays, such as that shown in FIG. 10, and the additional possible formats of these outputs, including paper printouts. The use of the displays in managing a complex IT environment and the further use of these tangible results as feedback to accomplish such management are important aspects of the present invention. Thus, the system and method (as implemented through technology) described herein produce these and other tangible results.

In accordance with an embodiment of the present invention, instructions adapted to be executed by a processor to perform a method are stored on a computer-readable medium. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

In the context of this document, a “computer-readable medium” can be any means that can contain, store, communicate, propagate, or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A computer-implemented system in a computer network of several node computers and a plurality of software program components, the system comprising:
a node computer of the several node computers;
software program components of the plurality of program components distributed instanced on the node computer and having a predetermined interface in each case, wherein for each interface is specified what inputs should be applied to address a functionality of the corresponding software program component and what outputs the functionality corresponding to the corresponding software program component will supply after its execution; and
a computer program component application landscape that, by communication with the software program components, records state information from at least one of software program resources and hardware resources in the computer network, the state information comprising
architecture information of the computer network,
configuration status of the hardware resources of the computer network,
event and error messages of the hardware resources of the computer network,
development status of the software program components,
runtime behavior of the software program components,
events and errors of the software program components,
data flow between at least one of individual software program components and hardware resources of the computer network, and
introduction and change requirements and information for at least one of the hardware resources of the computer network and the software program components,
wherein the computer program component application landscape records the state information with time, space, functional, and structural descriptors, and, dependent on queries, outputs the state information in one or more standardized output formats.

2. The system of claim 1, wherein the system standardizes information about information technology (IT) assets, the IT asset information comprising one of software, software version, hardware, hardware versions, data flows, development information, and monitoring information, and wherein the system represents the IT asset information graphically with their respective dependencies within the computer program component application landscape for evaluation, using a uniform data structure for entry of the IT assets and their operation.

3. The system of claim 1, wherein the system automatically records and monitors data streams, volume requirements of the data streams, properties of the occurrence or appearance of the data streams, and executions of programs, in order to investigate and minimize errors and breakdowns and to detect dependencies between separate software program components, hardware resources of the computer network, and combinations thereof.

4. The system of claim 1, wherein a software program component comprises one of a function, a procedure, a technical component, and a multilayered business service that accesses multiple software program components.

5. The system of claim 1, wherein, for each software program component, the system
during planning and structuring of the each software program component and its relationships to other software program components, electronically structures and documents relevant static data of the each software program component,
during programming and coding of the each software program component, accesses the relevant static data and refines and supplements the relevant static data with function calls, parameter transfer, and dynamic attributes,
during the lifetime of the each software program component, supplements the relevant static data with version information and runtime behavior, and
at the runtime of the each software program component,
draws from the relevant static data output log file entries of the each software program component,
evaluates, by the computer program component application landscape, the static and dynamic behavior of the each software program component from its output log file entries, and
verifies and outputs the relevant static data.

6. The system of claim 1, wherein the output occurs in a form that reproduces the relationships to and dependencies on other resources in the computer network, and includes at least one of a static, dynamic, and multilevel output of the state information.

7. The system of claim 1, wherein communication between the computer program component application landscape and the software program components takes place in one of batch processing and real time, for the state information.

8. The system of claim 1, wherein an operational error is communicated in the state information to the computer program component application landscape for the software program component, and wherein the software program component is displayed in the output together with at least one of its dependent computer program components and its involved hardware resources in the computer network.

9. The system of claim 1, wherein a user error is communicated in the state information to the computer program component application landscape for the software program component, and wherein the software program component is displayed in the output together with at least one of its dependent computer program components, current data records, and its involved hardware resources in the computer network.

10. The system of claim 1, wherein the system displays a measure of quality of service (QoS) for a program component, and of performance statistics including the average response time (target−actual), the minimum response time (target−actual), the maximum response time (target−actual), the time of last access, and the number of accesses per time unit.

11. A method for monitoring and managing a complex hardware/software architecture comprising a computer network of several node computers and a plurality of software program components, which are distributed instanced on one of the node computers and with predetermined input parameters for addressing a functionality of the software program component and with predetermined output parameters after its execution, the method comprising:
communicating, using a computer program component application landscape, with the software program components and hardware resources in the computer network;
recording state information from at least one of the software program components and the hardware resources, the state information comprising
architecture information of the computer network,
configuration status of the hardware resources of the computer network,
event and error messages of the hardware resources of the computer network,
development status of the software program components,
runtime behavior of the software program components,
events and errors of the software program components,
data flow between at least one of individual software program components and hardware resources of the computer network, and
introduction and change requirements and information for at least one of the hardware resources of the computer network and the software program components,
recording, in a database, the state information with time, space, functional, and structural descriptors; and
dependent on queries, outputting the state information in one or more standardized output formats.

12. The method of claim 11, further comprising
standardizing information about information technology (IT) assets, the IT asset information comprising one of software, software version, hardware, hardware versions, data flows, development information, and monitoring information, and
representing the IT asset information graphically with their respective dependencies within the computer program component application landscape for evaluation, using a uniform data structure for entry of the IT assets and their operation.

13. The method of claim 11, further comprising automatically recording and monitoring data streams, volume requirements of the data streams, properties of the occurrence or appearance of the data streams, and executions of programs, in order to investigate and minimize errors and breakdowns and to detect dependencies between separate software program components, hardware resources of the computer network, and combinations thereof.

14. The method of claim 11, wherein a software program component comprises one of a function, a procedure, a technical component, and a multilayered business service that accesses multiple software program components.

15. The method of claim 11, wherein, for each software program component, the method comprises
during planning and structuring of the each software program component and its relationships to other software program components, electronically structuring and documenting relevant static data of the each software program component,
during programming and coding of the each software program component, accessing the relevant static data and refining and supplementing the relevant static data with function calls, parameter transfer, and dynamic attributes,
during the lifetime of the each software program component, supplementing the relevant static data with version information and runtime behavior, and
at the runtime of the each software program component,
drawing from the relevant static data output log file entries of the each software program component,
evaluating, by the computer program component application landscape, the static and dynamic behavior of the each software program component from its output log file entries, and
verifying and outputting the relevant static data.

16. The method of claim 11, wherein the output occurs in a form that reproduces the relationships to and dependencies on other resources in the computer network.

17. The method of claim 11, wherein the output includes at least one of a static, dynamic, and multilevel output of the state information.

18. The method of claim 11, wherein communicating between the computer program component application landscape and the software program takes place in one of batch processing and real time, for the state information.

19. The method of claim 11, further comprising
communicating in the state information to the computer program component application landscape an operational error for the software program component, and
displaying in the output the software program component together with at least one of its dependent computer program components and its involved hardware resources in the computer network.

20. The method of claim 11, further comprising
communicating in the state information to the computer program component application landscape a user error for the software program component, and
displaying in the output the software program component together with at least one of its dependent computer program components, current data records, and its involved hardware resources in the computer network.

21. The method of claim 11, further comprising displaying a measure of quality of service (QoS) for a program component, and of performance statistics including the average response time (target−actual), the minimum response time (target−actual), the maximum response time (target−actual), the time of last access, and the number of accesses per time unit.

22. A computer-readable medium for monitoring and managing a complex hardware/software architecture comprising a computer network of several node computers and a plurality of software program components, which are distributed instanced on one of the node computers and with predetermined input parameters for addressing a functionality of the software program component and with predetermined output parameters after its execution, the computer-readable medium storing a plurality of executable program instructions, the plurality of executable program instructions responsive, when executed, to:
communicate, using a computer program component application landscape, with the software program components and hardware resources in the computer network;
record state information from at least one of the software program components and the hardware resources, the state information comprising
architecture information of the computer network,
configuration status of the hardware resources of the computer network,
event and error messages of the hardware resources of the computer network,
development status of the software program components,
runtime behavior of the software program components,
events and errors of the software program components,
data flow between at least one of individual software program components and hardware resources of the computer network, and
introduction and change requirements and information for at least one of the hardware resources of the computer network and the software program components,
record, in a database, the state information with time, space, functional, and structural descriptors; and
dependent on queries, output the state information in one or more standardized output formats.
